(19) United States
(12) Patent Application Publication
(10) Pub. No.: US 2009/0197033 A1
(43) Pub. Date: Aug. 6, 2009

(54) TRANSFER-PRINTING STICKER

(76) Inventor: Shih-Feng Lee, Wu-Ku Industrial Zone (TW)

Correspondence Address: LEONG C LEI, PMB # 1008, 1867 YGNACIO VALLEY ROAD, WALNUT CREEK, CA, 94598, US

(21) Appl. No.: 12/024,119

(22) Filed: Feb. 1, 2008

(51) Int. Cl. B32B 33/00

(52) U.S. Cl. 428/41.8

(57) ABSTRACT

A transfer-printing sticker includes a release paper, a transparent base paper, and first and second sticking members carrying different patterns with the patterns arranged between the base paper and the release paper. The first sticking member contains a first pattern that is arranged to contain hollow portions. The second sticking member contains a second pattern that is arranged in accordance with the hollow portions of the first pattern. To use the transfer-printing sticker, the release paper is removed and the base paper is stuck to an article or a piece of paper and with slightly pressurization, the patterns are transferred. The arrangements of the first and second patterns allow for formation of different transfer printing effects. The second pattern can be set in the hollow portions of the first pattern and thus both can be formed with the same piece of sticker paper.

### BACKGROUND OF THE INVENTION

(a) Technical Field of the Invention

The present invention relates to an improvement of sticker, and in particular to a sticker package that facilitates storage and use of the sticker.

(b) Description of the Prior Art

As shown in FIG. 1 of the attached drawings, a conventional sticker assembly is often formed by attaching a sticker 12 on a release paper 11 of substantially the same size. After being subjected to cutting operation, a three-dimensional sticker 13 in an elongated form is formed. To use, the sticker 13 is peeled off the release paper 11 for sticking to a target object, such as a piece of paper or an article. The conventional sticker 13 is made with a preset length so that when it is applied to an area of a greater length, more than one sticker 13 is needed and an obvious discontinuity or interrupt can be observed between adjacent stickers. This looks ugly. Further, if the sticker 13 comprises hollow portions, the segments of the sticker 13 that delimit the hollow portions must be separately and individually peeled off and then rejoin to other portions when the sticker 13 is attached to the target object. This often results in incomplete pattern of the sticker 13.

Thus, as shown in FIG. 2, another sticker is proposed, which comprises a sticker 21 attached to a base paper 22, which is in turn attached to a release paper 23. To use, the base paper is peeled off the release paper 23 and attached to a target object or a piece of paper for transfer printing. Such a sticker 21 is only a single and individual pattern and contains hollow portions that are not used. After the sticker is applied, there is often a blank space amounting to two-third of the surface area of the piece of paper to which the sticker is attached. This is quite a waste.

In view of these problems, the present invention is aimed to provide a transfer-printing sticker that overcomes the drawbacks of the conventional designs by enhancing usage of the transfer-printing sticker.

### SUMMARY OF THE INVENTION

The primary purpose of the present invention is to provide a transfer-printing sticker that facilitates the usage of transfer-printing sticker and can provide various effect of transfer printing to thereby enhance added value thereof and also effect environmental conservation.

In accordance with the present invention, a transfer-printing sticker is provided, comprising a release paper, a transparent base paper, and first and second sticking members carrying different patterns with the patterns arranged between the base paper and the release paper. The first sticking member contains a first pattern that is arranged to contain hollow portions. The second sticking member contains a second pattern that is arranged in accordance with the hollow portions of the first pattern. To use the transfer-printing sticker, the release paper is removed and the base paper is stuck to an article or a piece of paper and with slightly pressurization, the patterns are transferred. The arrangements of the first and second patterns allow for formation of different transfer printing effects. The second pattern can be set in the hollow portions of the first pattern and thus both can be formed with the same piece of sticker paper to thereby effect environmental protection and saving of natural resources.

In the transfer-printing sticker in accordance with the present invention, the first and second patterns are formed by cutting the same piece of sticker paper so that the sticker paper, after being attached and transferred, makes both the first and second patterns.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional sticker;

FIG. 2 is a perspective view of another conventional sticker;

FIG. 3 is an exploded view of a first sticking member that constitutes a transfer-printing sticker in accordance with the present invention;

FIG. 4 is an exploded view of a second sticking member that constitutes a transfer-printing sticker in accordance with the present invention;

FIG. 5 is a plan view of the first sticking member of the transfer-printing sticker of the present invention;

FIG. 6 is a plan view of the second sticking member of the transfer-printing sticker of the present invention;

FIG. 7 shows an example of a transferred pattern formed by the transfer-printing sticker of the present invention; and

FIGS. 8 and 9 show another example of transferred patterns formed by the transfer-printing sticker of the present invention.

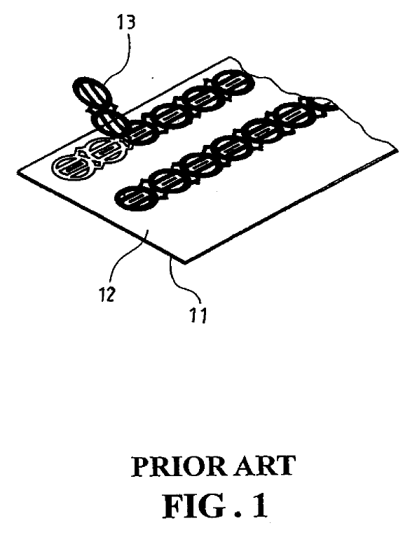

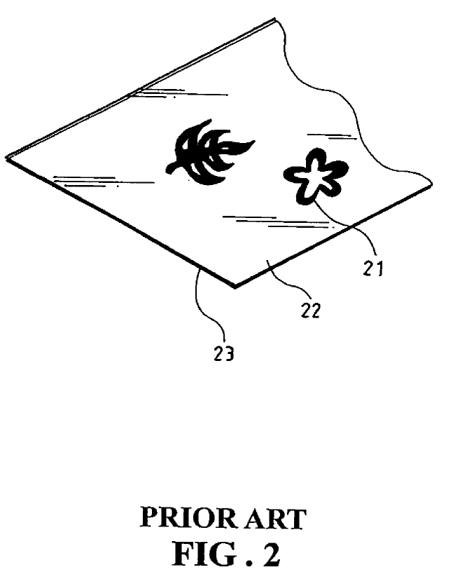

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

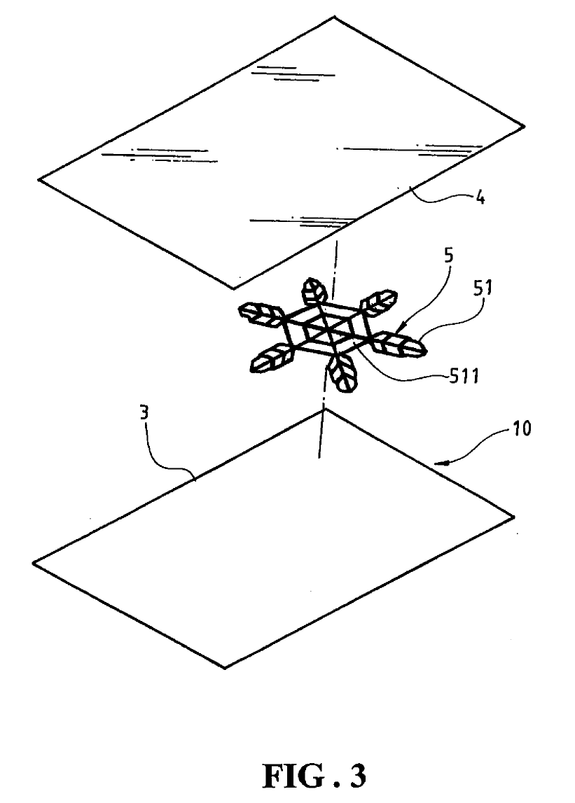

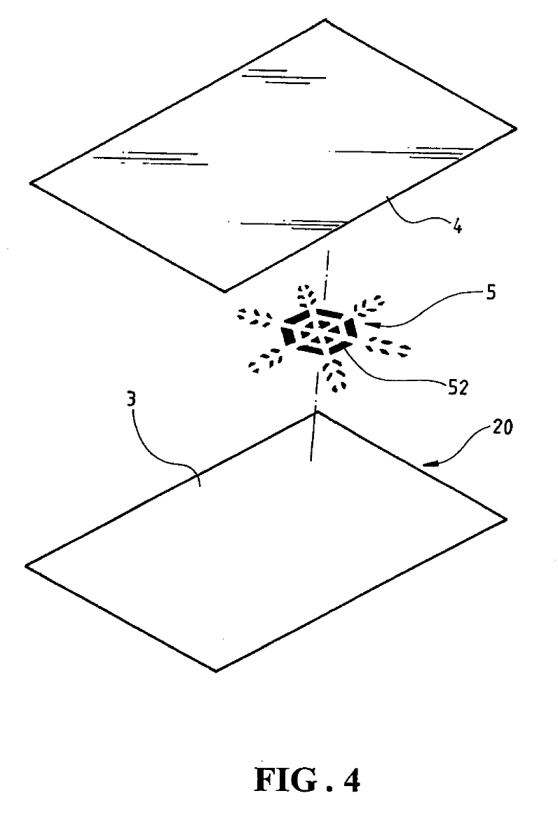

With reference to the drawings and in particular to FIGS. 3 and 4, the present invention provides a transfer-printing sticker that comprises a release paper 3, a transparent base paper 4, and first and second sticking members 10, made of different patterns 5. The patterns 5 are arranged between the base paper 4 and the release paper 3.

The patterns 5 of the first sticking member 10 may contain a first pattern 51 having hollow portions 511. The patterns 5 of the second sticking member 20 contain a second pattern 52 that is arranged in accordance with the hollow portions 511 of the first pattern 51.

A transfer-printing sticker in accordance with the present invention is thus formed with the combination of the above described constituent components. To use, the release paper 3 is peeled off the base paper 4 and the base paper 4 is then stuck to a target object, such as a piece of paper or an article. After being subjected to slight pressures, the patters 5 are transferred to the article or the piece of paper. The first and second patterns 51, 52 can be so arranged that different effect of transfer printing can be obtained Further, since the second pattern 52 is arranged in accordance with the hollow portions 511 of the first pattern 51, the second pattern 52 can be set in the hollow portions 511 of the first pattern 51 and thus a single piece of sticker paper can form both the first and second patterns 51, 52, making a saving of sticker paper and effecting environmental protection and saving of natural resources.

In the previously described transfer-printing sticker in accordance with the present invention, the first and second patterns 51, 52 are formed by cutting the same piece of sticker paper so that the sticker paper, after being attached and transferred, makes both the first and second patterns 51, 52.

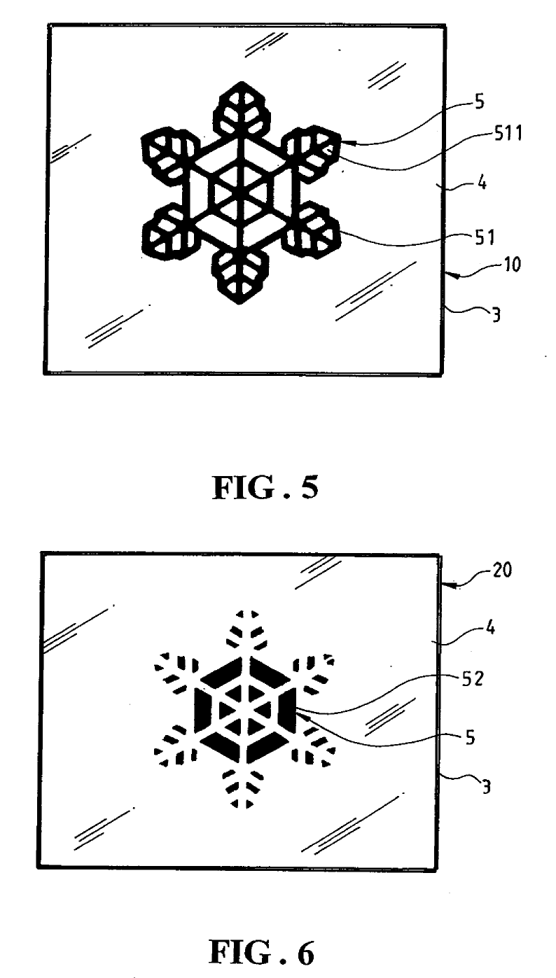

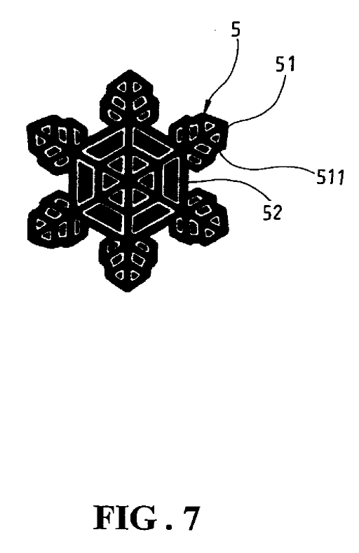

Also referring to FIGS. 5-7, to use the transfer-printing sticker of the present invention, the release papers 3 of the first sticking member 10 and the second sticking member 20 are removed from the base papers 4. The base papers 4 are stuck to an article or a piece of paper and after slight pressurization, the patterns 5 are transferred to the article or the piece of paper. Since the second pattern 52 that is of a different configuration or arrangement is set in the hollow portions 511 of the first pattern 51, once they are sequentially transferred to the piece of paper or the article, a complete pattern can be formed, leading to a desired effect of transfer printing, which does not contain any discontinuity and skewing and does not require separately peel off and stick individual segments of the patterns, making the use thereof extremely convenient.

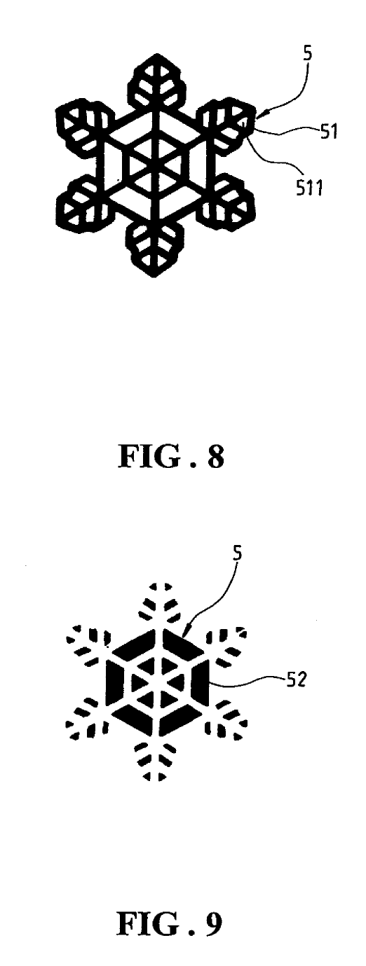

Also referring to FIGS. 8 and 9, another way of using the transfer-printing sticker in accordance with the present invention is provided, wherein the first pattern 51 of the first sticking member and the second pattern 52 of the second sticking member are separately transferred to different target objects to thereby provide an effect of transfer printing constituted by two different patterns.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A transfer-printing sticker comprising a release paper, a transparent base paper, and first and second sticking members carrying different patterns, wherein the patterns are arranged between the base paper and the release paper, the improvements comprising:
the first sticking member containing a first pattern that is arranged to contain at least one hollow portion, the second sticking member containing a second pattern that is arranged in accordance with the hollow portion of the first pattern, whereby in using the transfer-printing sticker, arrangements of the first and second patterns allow for formation of different results of transfer printing and whereby the second pattern is allowed to set in the hollow portion of the first pattern to thereby fully exploit surface area of a sticker paper and thus realizing environmental protection and saving of natural resources.
